(19) United States
(12) Patent Application Publication
(10) Pub. No.: US 2008/0313058 A1
(43) Pub. Date: Dec. 18, 2008

(54) Process And System For Identifying Demand For Inventory

(75) Inventors: Daniel J. Budnik, Southington, CT (US); Kalpesh Patel, Rocky Hill, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 11/762,828

(22) Filed: Jun. 14, 2007

(51) Int. Cl. G06Q 10/00

(52) U.S. Cl. 705/28; 705/8

(57) ABSTRACT

A computer-implemented process for identifying demand for excess inventory includes the steps of determining an inventory level and a forecasted demand of at least one part at least one facility; determining a part interchangeability of a first part with a second part of the at least one part; inputting an inventory level reflecting the part interchangeability and a forecasted demand reflecting the part interchangeability of the at least one part into an inventory module embodied in a server in communication with the at least one facility; accumulating the inventory level reflecting the part interchangeability and the forecasted demand reflecting the part interchangeability in the inventory module embodied in the server; determining an inventory position reflecting the part interchangeability for the at least one part for all of the at least one facility; determining a real-time demand reflecting the part interchangeability for the at least one part for all of the at least one facility; and conveying the real-time demand reflecting the part interchangeability for the at least one part to all of the at least one facility.

### TECHNICAL FIELD

This invention relates to inventory management and, more particularly, the invention relates to process(es) and system(s) for managing demand of inventory and mitigating excess inventory.

### BACKGROUND OF THE INVENTION

A maintenance facility can perform a variety of operations on an engine. While performing these maintenance operations, the maintenance facility must ensure that the engine retains a valid configuration. In other words, the maintenance facility must verify that each part used in the engine is compatible with the other parts used in the engine. This process is known as configuration management.

While simple in theory, real life configuration management creates a daunting task for the maintenance facility. Configuration management becomes increasingly convoluted with the successive complexity of the maintenance operation. Maintenance operations include, in increasing order of complexity, maintenance, repair and overhaul.

Conventional configuration management is so complex during an overhaul that maintenance facilities perform the process manually. In fact, maintenance facilities often use several individuals to perform this task. The individuals performing configuration management typically consult several discrete sources of information. These sources include Engine Manuals, Illustrated Parts Catalogs and Service Bulletins. These sources of information are either hard copies or electronic versions of the hard copy. By manually cross-referencing these discrete sources, the Individuals ensure that each part selected for reinstallation in the engine is proper and is compatible with the remaining parts.

However, such manual configuration management consumes a significant amount of time. In light of the increased time constraints placed on the maintenance facility during an overhaul, a desire exists for a replacement process that is quicker than conventional manual configuration management.

Conventional manual configuration management also requires multiple audits to ensure accuracy. Clearly, a desire exists for a replacement process that does not require such multiple audits.

Furthermore, conventional manual configuration management is incapable of repeatability. A maintenance facility performing the same maintenance operation on two identical engines would need to perform the same time consuming configuration management research twice. The individuals performing the research on the first engine cannot transfer this knowledge under the current manual process to the research for the second engine. Clearly, a desire exists for a replacement process that is repeatable.

Finally, conventional manual configuration management may not produce consistent results. For example, different individuals may interpret information contained within a service bulletin differently. These different interpretations may result in the issuance of different work instructions for an identical procedure. Clearly, a desire exists for a replacement process that provides consistent results.

### SUMMARY OF THE INVENTION

In accordance with one aspect of the present invention, a computer-implemented process for identifying demand for inventory broadly comprises determining an inventory level and a forecasted demand of at least one part at least one facility; determining a part interchangeability of a first part with a second part of the at least one part; inputting an inventory level reflecting the part interchangeability and a forecasted demand reflecting the part interchangeability of the at least one part into an inventory module embodied in a server in communication with the at least one facility; accumulating the inventory level reflecting the part interchangeability and the forecasted demand reflecting the part interchangeability in the inventory module embodied in the server; determining an inventory position reflecting the part interchangeability for the at least one part for all of the at least one facility; determining a real-time demand reflecting the part interchangeability for the at least one part for all of the at least one facility; and conveying the real-time demand reflecting the part interchangeability for the at least one part to all of the at least one facility.

In accordance with another aspect of the present invention, an inventory management system broadly comprises an inventory module embodied in a server in communication with at least one facility; means for inputting information connected to the server; and means for conveying information connected to the server, wherein the inventory module broadly comprises a program having a set of instructions executable to perform the steps of: an instruction to determine an inventory level and a forecasted demand of at least one part at least one facility; an instruction to determine a part interchangeability of a first part with a second part of the at least one part; an instruction to input an inventory level reflecting the part interchangeability and a forecasted demand reflecting the part interchangeability of the at least one part into an inventory module embodied in a server in communication with the at least one facility; an instruction to accumulate the inventory level reflecting the part interchangeability and the forecasted demand reflecting the part interchangeability in the inventory module embodied in the server; an instruction to determine an inventory position reflecting the part interchangeability for the at least one part for all of the at least one facility; an instruction to determine a real-time demand reflecting the part interchangeability for the at least one part for all of the at least one facility; and an instruction to convey the real-time demand reflecting the part interchangeability for the at least one part to all of the at least one facility.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a representation of a system for use in implementing the exemplary inventory management tool described herein;

FIG. 2 is a flow chart representing the inventory management process and system of the present invention for assessing each part's demand and determine part interchangeability;

FIGS. 3a and 3b are screen shots of the computer system in FIG. 2 at various stages in the performance of a second task;

FIG. 4 is a screen shot of the computer system during performance of a second task; and

FIG. 5 is another screen shot of the computer system during performance of a second task.

Like reference numbers and designations in the various drawings indicate like elements.

### DETAILED DESCRIPTION

The following terms and phrases will be used throughout the specification.

A Bill of Material (BOM) refers to a list of components that define a product, such as a gas turbine engine.

A Master Parts List or Grand BOM refers to a list of all potential parts that could be used in the product.

An As-Built BOM refers to a list of parts used by the Original Equipment Manufacturer (OEM) or the maintenance facility to assemble the product.

An As-Shipped BOM refers to a list of parts in the product when the OEM or the maintenance facility releases the product. Since the product may undergo testing after assembly, the As-Shipped BOM may not be the same as the As-Built BOM. If testing proves successful, the OEM or the maintenance facility releases the product engine and the As-Shipped BOM will mirror the As-Built BOM. If testing proves unsuccessful, the OEM or the maintenance facility may replace parts on the product and perform additional testing. If the OEM or the maintenance facility replaces parts, the As-Shipped BOM will not be the same as the As-Built BOM.

An As-Received Configuration refers to a list of parts found in the product by the maintenance facility during disassembly. If the maintenance facility performed the previous maintenance operation, then the As-Received Configuration will be the same as the As-Shipped BOM.

A Planned Configuration refers to a preliminary list of parts selected by the maintenance facility for reassembly into the product.

A Should Build Configuration refers to a list of parts selected by maintenance for reassembly into the product.

An Engine Manual refers to a publication that contains OEM and aviation authority (e.g. Federal Aviation Administration, Joint Aviation Authority, etc.) approved engine maintenance procedures.

An Illustrated Parts Catalog refers to a publication that provides part numbers and illustrations for parts used to manufacture an engine and for replacement parts.

A Service Bulletin refers to a publication containing OEM and aviation authority approved technical data for incorporating an engineering change into an existing engine. The Service Bulletin includes work instructions necessary to incorporate the engineering change into the engine.

An Add Parts List refers to the parts that the Service Bulletin can add to the engine.

A Cancel Parts List refers to the parts that the Service Bulletin can remove from the engine.

A Sets Requirement refers to a stipulation in the Service Bulletin that all of the parts on the Add Parts List must be added to the engine and that all of the parts on the Cancel Parts List must be removed from the engine. In other words, a Sets Requirement prohibits partial incorporation of the Service Bulletin.

A Prerequisite Service Bulletin refers to a Service Bulletin already incorporated into an engine before a maintenance facility performs the subject Service Bulletin. Typically, the subject Service Bulletin reworks some of the changes made by the Prerequisite Service Bulletin.

A Concurrent Service Bulletin refers to a Service Bulletin that a maintenance facility must accomplish at least simultaneously with the subject Service Bulletin.

A Superseding Service Bulletin refers to a Service Bulletin that replaces the subject Service Bulletin.

A Recommended Service Bulletin refers to a Service Bulletin that a maintenance facility should accomplish along with the subject Service Bulletin in order to gain maximum benefit of the Service Bulletins.

As used herein, the term “part number” may refer to an actual number used to identify a part, material, etc. or a drawing, for example, a blueprint, a CAD image, etc., associated with and also used to identify the part, material, etc.

While the inventory management process(es) and system(s) described herein may be used to manage any type of inventory on any manufacturing and/or organizational scale, the following exemplary description concerns managing demand of inventory and mitigating excess inventory of aircraft engine parts. Generally, the inventory management process(es) and system(s) described herein are considered enterprise level inventory analysis. More specifically, enterprise level inventory management process(es) and system(s) described herein aim to reduce excess inventory relative to forecasted demand over the next five (5) years. As is understood by one of ordinary skill in the art, inventory demand of parts is forecasted for a period of five years into the future.

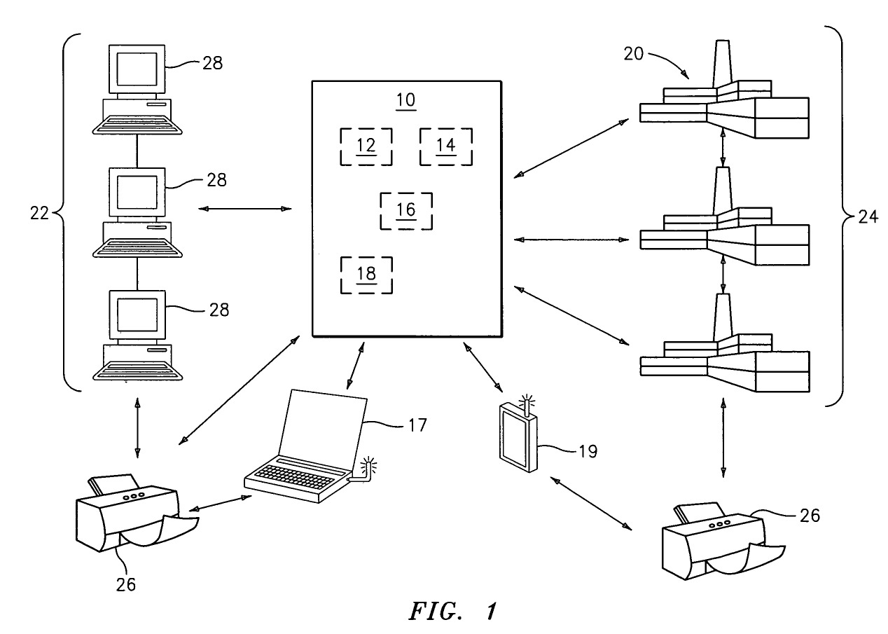

In one representative embodiment, a computer system, e.g., a host server with clientele computer, a computer, personal digital assistant, and the like, may be equipped with software embodying the inventory management process such that the computer system itself becomes a system for managing inventory demand and mitigating excess inventory. Suitable software for executing such programs may be commercially available from SAP America, Inc., Newtown Square, Pa. The computer system embodying the inventory management process and system described herein may include at least an inventory module 12 for carrying out the process. FIG. 1 illustrates a representative system having a server 10 embodying the hardware for computer-implemented process, e.g., inventory module 12, a planned configuration database 14, an SB database 16, and an IP database 18. The server 10 may include an input device, such as a computer, and a means for connecting serially to a computer 17, a personal digital assistant 19, and/or a manufacturing or maintenance facility 20, and/or a means for connecting in parallel to a plurality of computers 22 and/or a plurality of manufacturing or maintenance facilities 24, and one or more output device(s) such as a printer 26, monitor 28, and the like, connected with the server 10 and/or aforementioned input devices to generate a visual representation or hardcopy of the information produced by the exemplary system and process described herein. As illustrated, the connections amongst the devices may be hard wired or wirelessly connected as known to one of ordinary skill in the art. The user of the configuration management process and system described herein may implement the process and system on-site for example, at the manufacturing facility 20, at their office, or at another location off-site.

Generally, the maintenance facility begins the process at step 102 once the user selects a part, or material, utilizing the inventory management process and system. The facility 20 may first extract the selected part or material from an inventory database (not shown) at step 104. The inventory database may contain the inventory levels of each part in stock at the facility 20, including a system wide inventory representative of all the inventory levels of all the facilities 24 in communication with a server 109 utilizing the inventory management system described herein. Such information may be routinely input and updated daily by the facilities 24 to track inventory levels of each part on a day-to-day basis. Using this selected part information, the facility 20 may then apply a consumption forecast of the selected part at step 106. The consumption forecast provides the forecasted demand for the selected part at each maintenance facility.

The forecasted demand for the selected part may indicate the part exhibits over-demand (low inventory), under-demand (excess inventory) or non-demand (obsolescence). Historically, the response to discovering a part was in over-demand was to place an order for additional parts. An inventory configurator data/analysis 107 of the inventory management process and system described herein may be utilized to identify parts in over-demand and then explore the potential to restructure the configuration level of parts exhibiting under-demand or obsolescence. The potential restructuring may be accomplished by identifying part interchangeability and/or reoperating parts to higher configuration levels present within existing SBs.

Having knowledge of those materials which are interchangeable at the same configuration level brings a number of new capabilities as will be discussed herein. Materials, for example, are also inventoried by part number. Likewise, forecasted demand for a material is also accomplished by part number. Applying the knowledge of interchangeability rules enables both the demand for material and current inventory position to be aggregated or compared beyond the material number. There may be cases, for example, where there is high demand on a material which has a low inventory position and low demand on a material which has a high current inventory level. Knowledge of the fact that these materials are interchangeable would enable consumption of the material exhibiting under-demand or obsolescence while delaying the need to consume greater quantities of the material exhibiting over-demand.

Each maintenance facility routinely maintains information with regard to each part(s), material(s), etc., into the inventory module 12. Such part information includes not only part numbers but also part interchangeability information, commonly referred to as master data as known to one of ordinary skill in the art. Typically, there are three examples of part interchangeability information. First, the part list part number may be same part number utilized by the facility 20 or may correspond to a different part number utilized by the facility 20. The facility 20 may have assigned a new part number to the part. Although the part list part number and maintenance facility part number may be different, the parts are still the same. Secondly, the part list part number may correspond with a Vendor part number. Vendor part numbers are assigned by each vendor based upon the maintenance facility providing each vendor with their part number. And, each vendor may assign a different part number to the same part. Each vendor part number may be different from the maintenance facility part number originally provided them. In addition, the part list part number may also be different than maintenance facility part number and/or each vendor part number. Irrespective of how many different part numbers are assigned, the part list part number, maintenance facility part number and each vendor part number all correspond to the same part. Thirdly, the part list number may correspond with a field part number, that is, a part serviced, machined, reoperated in the field, for example, tarmac, hangar, etc. Again, the part list number and field part number, albeit different, may still correspond to the same part. In each of these non-limiting examples, the parts are interchangeable despite the part numbers being different. Such information is utilized by the inventory management process and system described herein to manage part demand and mitigate excess part inventory.

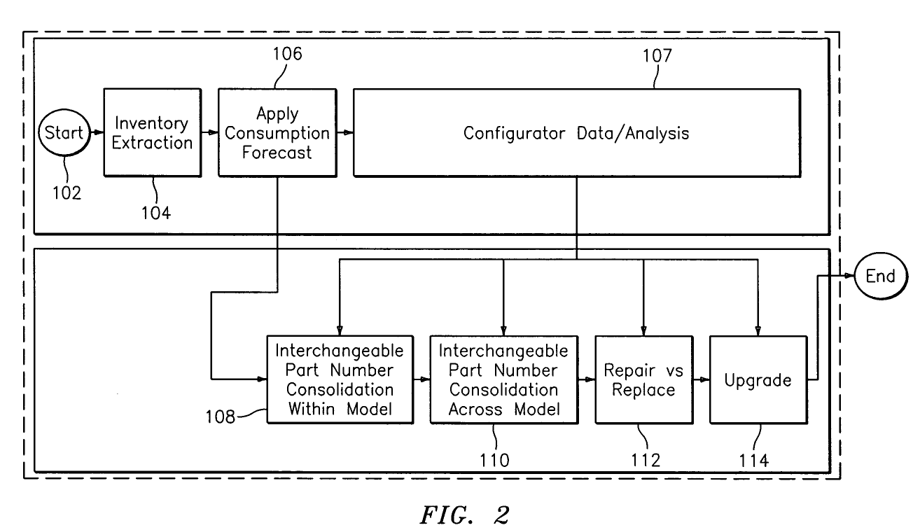

Referring again to FIG. 2, such part interchangeability and consolidation may take place at an enterprise level, for example, facility-wide level, within the sphere of a component or system of the engine (model) at a step 108, or across the entire engine (model) at a step 110. The inventory management process and system enables the maintenance facility to view, for a given part, all of the models which use that part within the universe of data within it. In contrast, the data provided by the engine manufacturers today is segregated by engine model group. Consequently, research into the applicability of a part across a number of engine model groups requires research into the technical data for each model group. However, the inventory management system and process now provides this information to the maintenance facilities.

First, the maintenance facility may use the part interchangeability knowledge to prioritize the development of new repairs. Furthermore, engine shops which have a current capability in a repair process for a given part number—model group usage can use this information to determine if they have current capability for other repairs. Secondly, the demand for parts which are used across engine model families can also be aggregated. The maintenance facility may generate the forecasted demand for part(s) for each model group. Therefore, aggregating the forecasted demand for these parts across all of the applicable models groups enables additional inventory optimization to occur.

Based upon part interchangeability, the maintenance facility may then decide whether to repair or replace a part at a step 112 or upgrade a part at a step 114 as shown in FIG. 2. The aftermarket configuration management functionality described herein contains the Master BOMs for the engine model groups of both PWA and non-PWA engines. At each location of the BOM, designated by a LID, this functionality contains the part genealogy or rules describing the allowable part progressions as a consequence of service bulletin incorporation into the material. The data contained within the configuration management system also describes the process by which a down part number may be brought to a higher configuration level. In some cases, the down part number may be removed and replaced with a new production part number. In these cases, there may be no opportunity to elevate a non-current demand part to a higher service bulletin status having potentially more demand. In many other cases, however, the down part number may be removed and can be re-operated to a higher configuration level. For these cases, the opportunity may exist to elevate non current demand materials to a higher configuration level. The inventory management process and system may be utilized to analyze the ranking level and progression level of the parts in inventory exhibiting under-demand or obsolescence, and output the update potential for these materials.

The opportunity to capitalize on this capability of the inventory management process and system described herein occurs during the engine overhaul process. During the process of inspecting a selected part(s) removed from an engine, a disposition decision is made on each of the parts in order to bring the BOM up to the configuration level as dictated by the customer supplied workscope. In some cases, the selected part removed from the engine may require processing, or reoperating, in order to bring the part to a higher configuration level as dictated by the workscope. For those cases where the processing required on the part results in a part number for which excess inventory has been identified with respect to a forecasted 5 year demand, the part could be intercepted from proceeding to the repair process. Such a part may then be supplied to the customer. The value of this part would then become the cost of the additional processing required on this outgoing part to bring it to the level of a current demand part.

The facility 20 may discover a sourcing problem with the selected part(s). As mentioned above, sourcing problems may include an unfillable order, part unavailability, excessive lead-time, or high part price. The inventory management system described herein may notify the facility 20 of this sourcing problem after comparing the planned configuration database 114 to a database (not shown) of parts affected by sourcing problems. The facility 20 may also learn of sourcing problems without notification from the inventory management system, for example, sourcing problems that have occurred after the most recent update of the database (not shown). However, the inventory management system is designed to prevent such an occurrence.

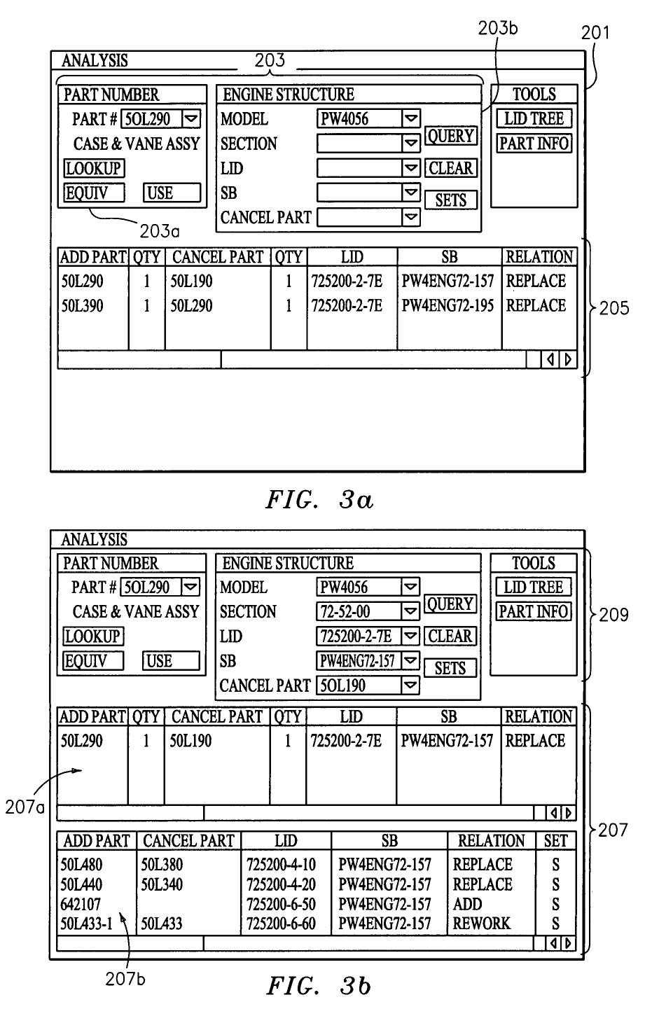

FIG. 3a displays a screen 201 generated by the analysis module 12 to assist the maintenance facility upon discovering an aforementioned sourcing problem. The screen 201 may include an input section 203 and a results section 205. However, other suitable graphical user interface and arrangement of fillable or non-fillable information fields may be used. The various sections will be described in more detail below.

The input section 203 of the screen 201 may allow the user to enter part-specific information in box 203a or more generalized information in box 203b. However, the program could use any type of information sufficient to assist the user in modifying the work scope. The user can manually provide the desired information using, for example, the computer 16, or the user could select options appearing in a drop-down box. For example, the inventory management system may pre-populate the input section 203 with information from the planned configuration database 16 on the server 10.

The inventory management system may then search the SB database 16 for instances of the information provided by the user to the input section 203. The system may display the results of such query in the results section 205. If no SB introduced the part, that is, no data appears in the results section 205, and then the selected part may be considered a basic part. As known to one of ordinary skill in the art, a basic part is a part installed during original assembly of the engine, that is, the part is in the As-Built BOM.

If the desired part number appears in more than one SB, for example, in the Add Parts List of one SB and in the Cancel Parts List in another SB, the user must specify one of the SBs before proceeding. Before choosing an SB, the user may obtain additional information regarding the SBs while in screen 201. For example, box 203b may allow the user to obtain information regarding Sets Requirements, Sets/Stage Requirements or Optional Dependency by selecting the Sets button. The program displays such information by opening another window (not shown).

As stated earlier, a Sets Requirement requires the replacement of every part on the Cancel Parts List of the SB with the parts on the Add Parts List of the SB. In other words, a Set Requirement prohibits intermix of parts from the Add Parts List with parts from the Cancelled Parts List. A Sets/Stage Requirement differs from a Sets Requirement. A Sets/Stage Requirement may arise when an SB deals with the same part number at multiple locations within the engine. The Sets/Stage Requirement allows partial incorporation of the SB by replacing all of the subject parts at one location within the engine. For example, a Sets/Stage Requirement could allow the maintenance facility to replace all of the compressor blades from the fifth stage, without replacing the sixth stage blades. The maintenance facility would fully incorporate the SB during a subsequent maintenance visit by replacing the sixth stage blades.

Optional Dependency differs from both a Sets Requirement and a Sets/Stage Requirement. An Optional Dependency indicates related parts within the Add Parts List. An assembly (such as a ring segment), which is formed by various subcomponents (such as vane assemblies and pins), typifies related parts within an SB. When an Optional Dependency exists, the program will display the options available for all of the related parts as a group.

The program may use a Location Identifier (LID) to designate a specific location for a part in the engine, since a given part number could reside at multiple locations in the engine. A LID has five fields. The first three fields follow Air Transport Association (ATA) Specification 100 standards that refer to the ATA Chapter, Section and Subject. The fourth and fifth fields equate to the IPC Figure and Item Number that display the part.

The screen 201 may also include a tools box 209. In the tools box 209, the user may obtain additional information with regard to the selected part. Specifically, the user can obtain information regarding optional parts for the current SB level. Optional part information lists interchangeable parts, that is, direct substitutes; alternate parts, for example, parts such as clamps, that are usable even if undersized or oversized from the desired sized; and, preferred parts, that is, the choice of one interchangeable part over another interchangeable part, for the current SB level. The inventory management system may also provide the user with information regarding sourcing problems by querying the sourcing problems database (not shown). The system may obtain this information by querying an IPC database 18 on the server 10. The IPC database 18 may include an electronic version of the hard copy IPC, for example, in HTML format, for viewing upon request by the user and a version of the IPC in a codification format understood by the inventory management system when accessed during a query.

Once the user selects the desired SB, the program refreshes the screen 201. In particular, the program populates input section 203b with the relevant SB information. The program also replaces the results section 205 with an output section 207. The program populates the output section 207 with information from a query to the SB database 16. A first section 207a of the output section 207 display parts added by the SB at the specific LID. A second section 207b of the output section 207 displays parts added by the SB at the other LIDs and which have a Sets Requirement.

As described earlier, the facility 20 has recognized a sourcing problem with a selected part. For example, the maintenance facility may have determined that part number 50L290 has a long lead time or a replacement part may not be readily available. This long lead time may affect the ability of the maintenance facility to complete the maintenance operation on time. The program allows the user to find a solution to the sourcing problem and to determine whether the solution is acceptable. Specifically, the program allows the user to determine if a suitable alternate part is available and whether the incorporation of the alternate part into the engine is a satisfactory solution.

The user has two options when determining the possibility of alternate parts. The user can search for an “up replacement” for the subject part or a “down replacement” for the subject part. An “up replacement” part is a part added by an SB which cancels the subject part. To use the “up replacement” part as the alternate part, the user would need to add the SB to the work scope. A “down replacement” part is a part cancelled by an SB which adds the subject part. To use the “down replacement” part as the alternate part, the user would need to modify the work scope to reverse the work steps described in the SB. Alternatively, the user may also repair the “down replacement” part to become a “current part” if lead time permits. The user may determine which “up replacement” and “down replacement” parts to select by choosing the LID tree button in the tools box 209. The LID tree button provides a graphical representation of the “up replacements” and “down replacements” of the subject part.

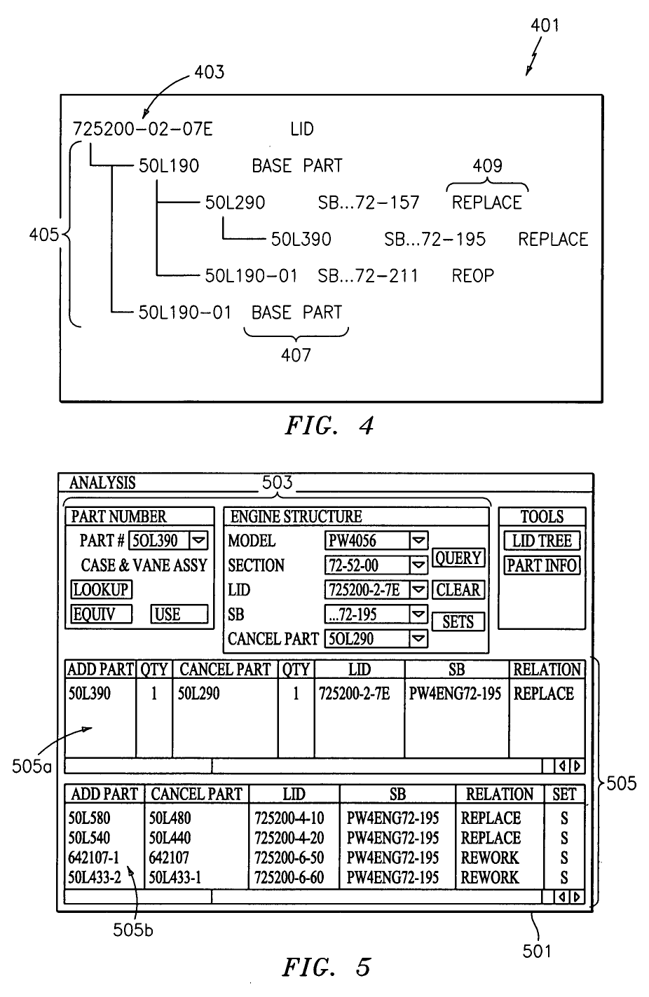

Referring now to FIG. 4, the inventory management system may provide this information in a pop-up screen 401 generated by the analysis module 12. The screen 401 provides engine location information 403, that is, LID; hierarchy information 405; incorporation information 407, that is, either displaying the SB that incorporated the part or an indication that the part is a basic part; and, operation information 409, that is, what the SB performs on the cancelled part. The inventory management system may obtain this information during multiple iterations of queries to the SB database 16. The system iterates until the down replacement query reaches basic parts and the up replacement query finds no additional data. Since the specific SB may affect other parts in the engine, for example, due to a Sets Requirement, the user must ensure that the use of such “up replacement” or “down replacement” alternate part does not affect the engine configuration, does not overly complicate the maintenance operation, or significantly increase the price of the maintenance operation. The user determines the impact of using an “up replacement” or a “down replacement” by selecting a possible replacement appearing in the hierarchy using, for example, the computer 101.

Referring now to FIG. 5, the program may then display information regarding the possible replacement part in another pop-up screen 501. When the user selects part number 50L390 as a possible replacement part, the system may launches a screen 501 containing information specific to the possible replacement part. The screen 501 may include an input section 503 and an output section 505. The system may populate the input section 503 with the information on the possible replacement part selected by the user. The inventory management system may then query the SB database 16 for information to populate the output section 505. A first section 505a of the output section 505 displays parts added by the SB at the LID of the possible replacement part. A second section 505b of the output section 505 displays parts added by the SB at other LIDs and which have a Sets Requirement. In other words, the screen 501 allows the user to the ease or the difficulty of using the possible replacement part to overcome the sourcing problem.

As represented in FIG. 5, using the “up replacement” part 501390 to avoid the hypothetical sourcing problem does not appear difficult. The user may determine the use of this part an acceptable solution. If the user does not determine the part is acceptable or the user chooses to continue investigating, then the user may close the screen 503 and return to the screen 401 to select another potential replacement part.

The inventory management system and process (es) have been described in connection with the various embodiments represented by the various figures. It is to be understood that other similar embodiments may be used or modifications and additions may be made to the described embodiment for performing the same function of the inventory management system and process(es) described herein without deviating therefrom. Therefore, the inventory management system and process(es) should not be limited to any single embodiment, but rather construed in breadth and scope in accordance with the recitation of the appended claims.

One or more embodiments of the present invention have been described. Nevertheless, it will be understood that various modifications may be made without departing from the spirit and scope of the invention. Accordingly, other embodiments are within the scope of the following claims.

What is claimed is:

1. A computer-implemented process for identifying demand for excess inventory, comprising:
determining an inventory level and a forecasted demand of at least one part at least one facility;
determining a part interchangeability of a first part with a second part of said at least one part;
inputting an inventory level reflecting said part interchangeability and a forecasted demand reflecting said part interchangeability of said at least one part into an inventory module embodied in a server in communication with said at least one facility;
accumulating said inventory level reflecting said part interchangeability and said forecasted demand reflecting said part interchangeability in said inventory module embodied in said server;
determining an inventory position reflecting said part interchangeability for said at least one part for all of said at least one facility;
determining a real-time demand reflecting said part interchangeability for said at least one part for all of said at least one facility; and
conveying said real-time demand reflecting said part interchangeability for said at least one part to all of said at least one facility.

2. The computer-implemented process of claim 1, further comprising the steps of:
determining a real-time demand for said first part indicates low inventory exists;
determining a real-time demand for said second part indicates excess inventory exists;
determining said first part and said second part are interchangeable;
replacing a second part number of said second part with a first part number of said first part in response to said real-time demand for said first part; and
conveying said replacement step to said at least one facility.

3. The computer-implemented process of claim 1, further comprising the steps of:
determining a real-time demand for said first part indicates excess inventory exists;
determining a real-time demand for said second part indicates low inventory exists;
determining said first part and said second part are interchangeable;
replacing a first part number of said first part with a second part number of said second part in response to said real-time demand for said second part; and
conveying said replacement step to said at least one facility.

4. The computer-implemented process of claim 1, further comprising the steps of:
determining a real-time demand for said at least one part indicates said at least one part is obsolete;
reoperating said at least one part to create at least one reoperated part;
elevating a ranking value and a progression level value for said at least one reoperated part to a higher configuration level; and
determining a real-time demand for said at least one reoperated part having said higher configuration level.

5. The computer-implemented process of claim 1, wherein determining said part interchangeability comprises comparing a part genealogy of said first part with said part genealogy of said second part.

6. The computer-implemented process of claim 4, wherein comparing comprises comparing at least one first ranking value and at least one first progression level value of said first part with at least one second ranking value and at least one second progression level value of said second part.

7. The computer-implemented process of claim 1, further comprising ordering said at least one part when said real-time demand reflecting said part interchangeability indicates low inventory exists for said at least one part.

8. The computer-implemented process of claim 1, further comprising consuming said at least one part when said real-time demand reflecting said part interchangeability indicates excess inventory exists for said at least one part.

9. The computer-implemented process of claim 1, further comprising determining said at least one part is obsolete when said real-time demand reflects there are no possible interchangeable parts.

10. The computer-implemented process of claim 1, wherein determining said real-time demand reflecting said part interchangeability comprises determining said real-time demand reflecting said part interchangeability is an under-demand status, an over-demand status or zero.

11. The computer-implemented process of claim 1, wherein inputting comprises inputting said inventory level and said forecasted demand from a plurality of facilities.

12. An inventory management system, comprising:
an inventory module embodied in a server in communication with at least one facility;
means for inputting information connected to said server; and
means for conveying information connected to said server, wherein said inventory module comprises a program having a set of instructions executable to perform the steps of:
an instruction to determine an inventory level and a forecasted demand of at least one part at least one facility;
an instruction to determine a part interchangeability of a first part with a second part of said at least one part;
an instruction to input an inventory level reflecting said part interchangeability and a forecasted demand reflecting said part interchangeability of said at least one part into an inventory module embodied in a server in communication with said at least one facility;
an instruction to accumulate said inventory level reflecting said part interchangeability and said forecasted demand reflecting said part interchangeability in said inventory module embodied in said server;
an instruction to determine an inventory position reflecting said part interchangeability for said at least one part for all of said at least one facility;
an instruction to determine a real-time demand reflecting said part interchangeability for said at least one part for all of said at least one facility; and
an instruction to convey said real-time demand reflecting said part interchangeability for said at least one part to all of said at least one facility.

13. The inventory management system of claim 12, further comprising the steps of:
an instruction to determine a real-time demand for said first part indicates low inventory exists;
an instruction to determine a real-time demand for said second part indicates excess inventory exists;
an instruction to determine said first part and said second part are interchangeable;
an instruction to replace a second part number of said second part with a first part number of said first part in response to said real-time demand for said first part; and
an instruction to convey said replacement step to said at least one facility.

14. The inventory management system of claim 12, further comprising the steps of:
an instruction to determine a real-time demand for said first part indicates excess inventory exists;
an instruction to determine a real-time demand for said second part indicates low inventory exists;
an instruction to determine said first part and said second part are interchangeable;
an instruction to replace a first part number of said first part with a second part number of said second part in response to said real-time demand for said second part; and
an instruction to convey said replacement step to said at least one facility.

15. The inventory management system of claim 12, further comprising the steps of:
determining a real-time demand for said at least one part indicates said at least one part is obsolete;
reoperating said at least one part to create at least one reoperated part;
elevating a ranking value and a progression level value for said at least one reoperated part to a higher configuration level;
determining a real-time demand for said at least one reoperated part having said higher configuration level; and.

16. The inventory management system of claim 12, wherein said instruction to determine said part interchangeability comprises an instruction to compare a part genealogy of said first part with said part genealogy of said second part.

17. The inventory management system of claim 16, wherein said instruction to compare comprises an instruction to compare at least one first ranking value and at least one first progression level value of said first part with at least one second ranking value and at least one second progression level value of said second part.

18. The inventory management system of claim 12, further comprising an instruction to order said at least one part when said real-time demand reflecting said part interchangeability indicates low inventory exists for said at least one part.

19. The inventory management system of claim 12, further comprising an instruction to consume said at least one part when said real-time demand reflecting said part interchangeability indicates excess inventory exists for said at least one part.

20. The inventory management system of claim 12, further comprising an instruction to determine said at least one part is obsolete when said real-time demand reflects there are no possible interchangeable parts.

21. The inventory management system of claim 12, wherein said instruction to determine said real-time demand reflecting said part interchangeability comprises an instruction to determine said real-time demand reflecting said part interchangeability is an under-demand status, an over-demand status or zero.

22. The inventory management system of claim 12, wherein said instruction to input comprises an instruction to input said inventory level and said forecasted demand from a plurality of facilities.
